(19) United States
(12) Patent Application Publication
(10) Pub. No.: US 2005/0197855 A1
(43) Pub. Date: Sep. 8, 2005

(54) Method and apparatus for renting items

(76) Inventor: Geoffrey H. Nudd, Evanston, IL (US)

Correspondence Address: William C. Milks, III;RUSSO & HALE LLP, 401 Florence Street, Palo Alto, CA, 94301, US

(21) Appl. No.: 11/066,588

(22) Filed: Feb. 24, 2005

Related U.S. Application Data
(60) Provisional application No. 60/548,771, filed on Feb. 26, 2004.

(51) Int. Cl. G06F 17/60

(52) U.S. Cl. 705/1

(57) ABSTRACT

According to a computer-implemented approach for renting items to customers, customers specify what items to rent using item selection criteria separate from deciding when to receive the specified items. According to the approach, customers provide item selection criteria to a provider. The provider provides the items indicated by the item selection criteria to customer over a delivery channel. The provider may be either centralized or distributed depending upon the requirements of a particular application. Each item is assigned a specific value, such as a number of points. A “SIMULTANEOUS-VALUE” method allows users to rent items up to a limit such that the total value assigned to the items currently provided does not exceed some limit, possibly also with a maximum number of exchanges. A “TIME LIMIT-VALUE” method accrues a value each time an item is provided, and allows exchanges to occur up to the value limit during a specified period of time, possibly also with a maximum number of exchanges. “SIMULTANEOUS-VALUE” and “TIME LIMIT-VALUE” methods may be used together or separately with a variety of subscription methodologies. The points assigned to each item may vary with certain business conditions. For instance, an item that is low in inventory may be assigned a higher value.

### CROSS-REFERENCE TO RELATED PATENT APPLICATION

This application relates to U.S. Provisional Patent Application No. 60/548,771, filed on Feb. 26, 2004, entitled METHOD AND APPARATUS FOR RENTING ITEMS.

### FIELD OF THE INVENTION

The present invention relates to inventory rental, and, more specifically, to a method and apparatus for renting items to customers.

### BACKGROUND OF THE INVENTION

### REFERENCES

U.S. Patent Documents

| | | |
|---|---|---|
| 5664110 | September, 1997 | Green, et al. |
| 5918213 | June, 1999 | Bernard, et al. |
| 6584450 | June, 2003 | Hastings, et al. |

Foreign Patent Documents

| | | |
|---|---|---|
| 2001-243285 | September, 2001 | JP |

### OTHER REFERENCES

“The Future of Television,” Brad Dick, Editor, Broadcast Engineering, NA, December, 1999.
Web page printout for http://www.netflix.com on Jan. 17, 1999, at http://web.archive.org/web/19990117080920/http://www.netflix.com/.
“About Us” web page from www.netflix.com.

Conventional inventory rental models are typically based upon renting items for fixed rental periods and charging late fees for keeping rented items beyond a specified return date. These types of inventory models suffer from several significant limitations. First, conventional rental models require customers to make the decision of what items to rent at substantially the same time as the decision of when to rent the items. An example that illustrates this limitation is a video rental business. Customers go to a video rental store and select particular movies to rent at that time. The customers take the movies home and must return them by a particular due date or be charged a late fee. In this situation, the customers cannot decide what movies to rent before actually renting them. The customers may have a particular movie in mind, but there is no guarantee that the video rental store has the particular movie in stock. Moreover, due dates are inconvenient for customers, particularly for “new release” movies that are generally due back the next day.

U.S. Pat. No. 6,584,450 provides an approach for renting items to a customer that does not suffer from limitations associated with conventional inventory rental models. U.S. Pat. No. 6,584,450 discloses an approach for renting inventory items to customers that allows separation of customers' decisions of what items to rent from when the items are rented, which is highly desirable. It provides an approach for renting items to customers on a continuous basis that avoids the use of fixed due dates or rental “windows” appurtenant to conventional rental models.

However, there is further need for improvements, in particular improvements that allow the rental item provider to moderate demand and supply for rental items. For instance, a movie that is in heavy demand under the prior approaches will be depleted under existing methods with no technique for the rental item provider to moderate demand.

Furthermore, there is a need for an approach that optimizes the distribution of goods to those who value them most. A rental item may be worth more to some customers than to others. Under the current approaches, there is no way to match an item with the customer who values it most.

Furthermore, there is a need for an approach that refines the criteria by which items are provided to the customer. For instance, it may be economical to rent a customer more small items than it is possible to rent large items. The approach disclosed in U.S. Pat. No. 6,584,450 does not allow the rental item provider to distinguish the number of items provided to the customer by weight or volume of the items provided. The method and apparatus in accordance with the present invention addresses these needs, all as will become clear herein.

### SUMMARY OF THE INVENTION

According to one aspect of the present invention, a method is provided for renting items to customers on a subscription basis. A limiting criterion, not defined in terms of the number of items provided (such as a number of points allocated to the customer, with each rental item being assigned a specific point value, and with the condition that the total points assigned to items provided to the customer must be within the customer's allocation) limits the items that a customer may rent. In response to one or more item delivery criteria being satisfied (such as a return of one or more previously rented items), one or more other items are provided to the customer, wherein the customer does not exceed the limit defined by the limiting criterion, and wherein the limiting criterion is not defined as the number of items currently provided, nor is the limiting criterion defined as the number of items provided within a specified period of time. The rental items may be movies, games, books, or any other item.

According to another aspect of the present invention, a method is provided for renting items to customers. According to the method, one or more item selection criteria are received that indicate one or more items that a customer desires to rent. A limiting criterion, not defined in terms of the number of items provided, (such as a number of points allocated to the customer, with each rental item being assigned a specific point value, and with the condition that the total points assigned to items provided to the customer must be within the customer's allocation) limits the items that a customer may rent. In response to one or more item delivery criteria being satisfied (such as a return of one or more previously rented items), one or more other items are provided to the customer, wherein the customer does not exceed the limit defined by the limiting criterion, and wherein the limiting criterion is not defined as the number of items currently provided, nor is the limiting criterion defined as the number of items provided within a specified period of time. The rental items may be movies, games, books, or any other item.

According to another aspect of the present invention, a computer-implemented apparatus is provided for renting items to customers. According to the apparatus, one or more item selection criteria are received that indicate one or more items that a customer desires to rent. A limiting criterion, not defined in terms of the number of items provided (such as a number of points allocated to the customer, with each rental item being assigned a specific point value, and with the condition that the total points assigned to items provided to the customer must be within the customer's allocation) limits the items that a customer may rent. In response to one or more item delivery criteria being satisfied (such as a return of one or more previously rented items), one or more other items are provided to the customer, wherein the customer does not exceed the limit defined by the limiting criterion, and where the limiting criterion is not defined as the number of items currently provided, nor is the limiting criterion defined as the number of items provided within a specified period of time. The rental items may be movies, games, books, or any other item.

According to another aspect of the present invention, a computer-implemented apparatus is provided for renting items to customers. According to the method, one or more item selection criteria are received that indicate one or more items that a customer desires to rent. A limiting criterion creates an allocation of rentals to a customer for a specified period of time (such as a number of points allocated to the customer for a specific period of time, with each item being assigned a specific point value, and with the condition that the total points assigned to items provided to the customer must be less than the points allocated to the customer for that time period). In response to one or more item delivery criteria being satisfied (such as a return of one or more previously rented items), one or more other items are provided to the customer, wherein the customer does not exceed the allocation of rentals defined by the limiting criterion for the specified period of time, and wherein the limiting criterion is not defined as the number of items currently provided, nor is the limiting criterion defined as the number of items provided within a specified period of time. The rental items may be movies, games, books, or any other item.

According to one preferred embodiment of the present invention, a method is provided for renting movies to customers. Each movie is assigned a number of points. Each customer is assigned an allocation of points. Movies are provided to the customer up to a limit such that the total points assigned to movies currently provided to the customer are less than the customer's point allocation. In response to a return of any of the movies provided to the customer, one or more other movies are provided to the customer, wherein the total points assigned to movies currently provided are less than the customer's point allocation.

According to another preferred embodiment of the present invention, a method is provided for renting movies to customers. Each movie is assigned a number of points. Each customer is assigned an allocation of points for a specified period of time. Movies are provided to the customer up to a limit such that the total points assigned to movies currently provided to the customer are less than the customer's point allocation for the specified period of time. In response to a return of any of the movies provided to the customer within the specified period of time, one or more other movies are provided to the customer, wherein the total points assigned to movies currently provided to the customer are less than the customer's point allocation for the specified period of time.

According to yet another preferred embodiment of the present invention, a method is provided for renting movies to customers. Each movie is assigned a value. Each customer is assigned an allocation of value. Movies are provided to the customer up to a limit such that the total value assigned to movies currently provided to the customer is less than the customer's value allocation. In response to a return of any of the movies provided to the customer, one or more other movies are provided to the customer, wherein the total value assigned to movies currently provided to the customer is less than the customer's value allocation.

According to a further preferred embodiment of the present invention, a method is provided for renting movies to customers. Each movie is assigned a value. Each customer is assigned a value for a specified period of time. Movies are provided to the customer up to a limit such that the total value assigned to movies currently provided to the customer is less than the customer's value allocation for a specified period of time. In response to a return of any of the movies provided to the customer within the specified period of time, one or more other movies are provided to the customer, wherein the total value assigned to movies currently provided to the customer is less than the customer's allocation for the specified period of time.

According to another preferred embodiment of the present invention, a computer-implemented apparatus is provided for renting movies to customers. Each movie is assigned a number of points. Each customer is assigned an allocation of points. Movies are provided to the customer up to a limit such that the total points assigned to movies currently provided to the customer are less than the customer's point allocation. In response to a return of any of the movies provided to the customer, one or more other movies are provided to the customer, wherein the total points assigned to movies currently provided to the customer are less than the customer's point allocation.

According to yet another preferred embodiment of the present invention, a computer-implemented apparatus is provided for renting movies to customers. Each movie is assigned a number of points. Each customer is assigned an allocation of points for a specified period of time. Movies are provided to the customer up to a limit such that the total points assigned to movies currently provided to the customer are less than the customer's point allocation for the specified period of time. In response to a return of any of the movies provided to the customer with the specified period of time, one or more other movies are provided to the customer, wherein the total points assigned to movies currently provided to the customer are less than the customer's point allocation for the specified period of time.

According to a further preferred embodiment of the present invention, a computer-implemented apparatus is provided for renting movies to customers. Each movie is assigned a value. Each customer is assigned an allocation of value. Movies are provided to the customer up to a limit such that the total value assigned to movies currently provided to the customer are less than the customer's value allocation. In response to a return of any of the movies provided to the customer, one or more other movies are provided to the customer, wherein the total value assigned to movies currently provided to the customer are less than the customer's value allocation.

According to a still further preferred embodiment of the present invention, a computer-implemented apparatus is provided for renting movies to customers. Each movie is assigned a value. Each customer is assigned a value for a specified period of time. Movies are provided to the customer up to a limit such that the total value assigned to movies currently provided to the customer is less than the customer's value allocation for the specified period of time. In response to a return of any of the movies provided to the customer, one or more other movies are provided to the customer within the specified period of time, wherein the total value assigned to movies currently provided to the customer is less than the customer's allocation for the specified period of time.

According to one preferred embodiment of the present invention, an apparatus for renting items to customers is provided. The apparatus comprises one or more processors and a memory communicatively coupled to the one or more processors. The memory includes one or more sequences of one or more instructions which, when executed by the one or more processors, cause the one or more processors to perform several steps. First, one or more item selection criteria are received that indicate one or more items that a customer desires to rent. A limiting criterion, not defined in terms of the number of items provided, (such as a number of points allocated to the customer, with each rental item being assigned a specific point value, and with the condition that the total points assigned to items provided to the customer must be within the customer's point allocation) limits the items that a customer may rent. Finally, in response to one or more item delivery criteria being satisfied (such as a return of one or more previously rented items), one or more other items are provided to the customer, wherein the customer does not exceed the limit defined by the limiting criterion, and wherein the limiting criterion is not defined as the number of items currently criterion, nor is the limiting criterion defined as the number of items provided within a specified period of time. The rental items may be movies, games, books, or any other item.

According to another preferred embodiment of the present invention, an apparatus for renting items to customers is provided. The apparatus comprises one or more processors and a memory communicatively coupled to the one or more processors. The memory includes one or more sequences of one or more instructions which, when executed by the one or more processors, cause the one or more processors to perform several steps. First, one or more item selection criteria are received that indicate one or more items that a customer desires to rent. Second, each item is assigned a number of points. The points assigned to each item may vary automatically or may be assigned automatically based on any criteria (such as current supply and/or demand for the item, expected supply and/or demand for the item, newness of the item in the marketplace, size and/or weight of the item, and the like). Each customer is assigned an allocation of points. Items are provided to the customer up to a limit such that the total points assigned to items currently provided to the customer are less than the customer's point allocation. In response to a return of any of the items provided to the customer, one or more other items are provided to the customer, wherein the total points assigned to items currently provided to the customer are less than the customer's point allocation. The rental items may be movies, games, books, or any other item.

According to yet another preferred embodiment of the present invention, an apparatus for renting items to customers is provided. The apparatus comprises one or more processors and a memory communicatively coupled to the one or more processors. The memory includes one or more sequences of one or more instructions which, when executed by the one or more processors, cause the one or more processors to perform several steps. First, one or more item selection criteria are received that indicate one or more items that a customer desires to rent. Second, each item is assigned a value. The value assigned to each item may vary automatically or may be assigned automatically based on any criteria (such as current supply and/or demand for the item, expected supply and/or demand for the item, newness of the item in the marketplace, size and/or weight of the item, and the like). Each customer is assigned an allocation of value. Items are provided to the customer up to a limit such that the total value assigned to items currently provided are less than the customer's value allocation. In response to a return of any of the items provided to the customer, one or more other items are provided to the customer, wherein the total value assigned to items currently provided to the customer are less than the customer's value allocation. The rental items may be movies, games, books, or any other item.

According to another preferred embodiment of the present invention, an apparatus for renting items to customers is provided. The apparatus comprises an item rental mechanism configured to perform several steps. First, one or more item selection criteria are received that indicate one or more items that a customer desires to rent. A limiting criterion, not defined in terms of the number of items provided (such as a number of points allocated to the customer, with each rental item being assigned a specific point value, and with the condition that the total points assigned to items provided to the customer must be within the customer's point allocation) limits the items that a customer may rent. Finally, in response to one or more item delivery criteria being satisfied (such as a return of one or more previously rented items), one or more other items are provided to the customer, wherein the customer does not exceed the limit defined by the limiting criterion, and wherein the limiting criterion is not defined as the number of items currently provided, nor is the limiting criterion defined as the number of items provided within a specified period of time. The rental items may be movies, games, books, or any other item.

According to yet another preferred embodiment of the present invention, an apparatus for renting items to customers is provided. The apparatus comprises an item rental mechanism configured to perform several steps. First, one or more item selection criteria are received that indicate one or more items that a customer desires to rent. Second, each item is assigned a number of points. The points assigned to each item may vary automatically or may be assigned automatically based on any criteria (such as current supply and/or demand for the item, expected supply and/or demand for the item, newness of the item in the marketplace, size and/or weight of the item, and the like). Each customer is assigned an allocation of points. Items are provided to the customer up to a limit such that the total points assigned to items currently provided to the customer are less than the customer's point allocation. In response to a return of any of the items provided to the customer, one or more other items are provided to the customer, wherein the total points assigned to items currently provided to the customer are less than the customer's point allocation. The rental items may be movies, games, books, or any other item.

According to a further preferred embodiment aspect of the present invention, an apparatus for renting items to customers is provided. The apparatus comprises an item rental mechanism configured to perform several steps. First, one or more item selection criteria are received that indicate one or more items that a customer desires to rent. Second, each item is assigned a value. The value assigned to each item may vary automatically or may be assigned automatically based on any criteria (such as current supply and/or demand for the item, expected supply and/or demand for the item, newness of the item in the marketplace, size and/or weight of the item, and the like). Each customer is assigned an allocation of value. Items are provided to the customer up to a limit such that the total value assigned to items currently provided to the customer are less than the customer's value allocation. In response to a return of any of the items provided to the customer, one or more other items are provided to the customer, wherein the total value assigned to items currently provided to the customer are less than the customer's value allocation. The rental items may be movies, games, books, or any other item.

### BRIEF DESCRIPTION OF THE DRAWINGS

Various preferred embodiments of the present invention are illustrated by way of example, and not by way of limitation, in the figures of the accompanying drawing and in which like reference numerals refer to similar elements and in which:

FIG. 1 is a diagram depicting a method for renting items to customers according to one embodiment of the present invention;

FIG. 2 is a flow diagram depicting a method for renting items to customers according to one preferred embodiment of the present invention;

FIG. 3 is a flow diagram depicting a “SIMULTANEOUS-VALUE” method for renting items to customers according to a preferred embodiment of the present invention;

FIG. 4 is a flow diagram depicting a “TIME LIMIT-VALUE” method for renting items to customers according to another preferred embodiment of the present invention.

FIG. 5 is a diagram depicting a method for renting audio/video items to customers over the Internet according to one preferred embodiment of the present invention;

FIG. 6 is a flow diagram illustrating an method for renting audio/video items to customers over the Internet using both “SIMULTANEOUS-VALUE” and “TIME LIMIT-VALUE” according to another preferred embodiment of the present invention;

FIG. 7 is a block diagram of a computer system upon which various preferred embodiments of the methods in accordance with the present invention may be implemented; and

FIG. 8 is a flow diagram illustrating a method for renting items to customers over a communications network such as the Internet using both or either “SIMULTANEOUS-VALUE” and “TIME LIMIT-VALUE” according to one preferred embodiment of the present invention.

### DETAILED DESCRIPTION OF THE PREFERRED EMBODIMENTS

In the following description, for the purposes of explanation, specific details are set forth in order to provide a thorough understanding of the present invention. However, it will be apparent that the present invention may be practiced without these specific details. In other instances, well-known structures and devices are depicted in block diagram form in order to avoid unnecessarily obscuring the present invention.

Various aspects and features of exemplary embodiments of the present invention are described in more detail hereinafter in the following sections: (1) functional overview; (2) item selection criteria; (3) item delivery; (4) “SIMULTANEOUS VALUE”; (5) “TIME LIMIT-VALUE”; (6) inventory management; (7) implementation mechanisms; and (8) assigning a value to each item.

1. Functional Overview

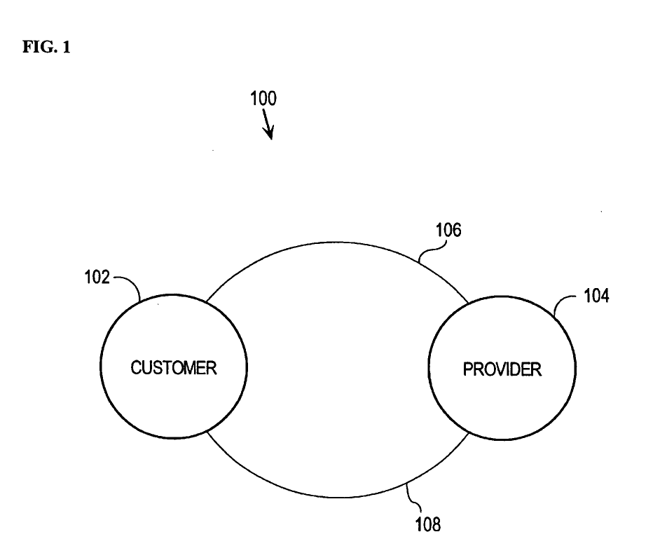

FIG. 1 is a block diagram 100 that illustrates a method for renting items to customers according to various preferred embodiments described herein. As used herein, the term “items” refers to any commercial goods that can be rented to customers. Examples of items include movies, music, and games stored on a non-volatile memory such as a tape, other magnetic medium, optical medium, read-only memory, or the like, but the present invention is not limited to any particular type of item. In general, the decision of what items to rent is separated from the decision of when to rent the items. Customers may specify what items to rent using one or more item selection criteria separate from deciding when to receive the specified items. Furthermore, customers are not constrained by conventional rental “windows” and instead can engage in continuous, serialized rental of items.

According to one preferred embodiment of the present invention, a customer 102 provides one or more item selection criteria to a provider of rental items 104 over a link 106. Link 106 may be any medium for transferring data between customer 102 and provider 104; and the present invention is not limited to any particular medium. Examples of link 106 include, without limitation, a network such as a LAN, WAN, or the Internet, a telecommunications link, a wire or optical link, or a wireless connection.

The item selection criteria indicate items that customer 102 desires to rent from provider 104. In response to receiving the item selection criteria from customer 102, provider 104 provides the items indicated by the item selection criteria to customer 102 over a channel 108. The channel 108 may be implemented by any mechanism or medium that provides for the transfer of items from provider 104 to customer 102, and the present invention is not limited to any particular type of channel. Examples of channel 108 include, without limitation, mail delivery, courier delivery, delivery using a delivery agent, retail store, or electronic delivery of data that comprises the rental item. Provider 104 may be centralized or distributed depending upon the requirements of a particular application.

According to one preferred embodiment of the present invention, a “SIMULTANEOUS VALUE” method allows up to a specified limit of items to be rented simultaneously to customer 102 by provider 104, based on a limiting criterion by which each rental item is assigned a value, such as a number of points, each customer is assigned a specified allocation of value, such as a total number of points, and the customer may be simultaneously provided rental items such that the total value assigned to items currently provided to the customer is less than the customer's value allocation. For example, the value system used may include, without limitation, a point value system, a monetary value system, or a credit value system. The value assigned to each rental item may be based on any criteria, and may be automatically assigned and may automatically vary. Examples of criteria for assigning value to items include, without limitation, current supply and/or demand for the item, expected supply and/or demand for the item, newness of the item in the marketplace, size and/or weight of the item, and the like.

According to another preferred embodiment of the present invention, a “TIME LIMIT-VALUE” method allows up to a specified limit of items to be rented to customer 102 by provider 104, based on a limiting criterion by which each rental item is assigned a value, such as a number of points, each customer is assigned a specified allocation of value for a specified period of time, such as a number of points for a month, and the customer may be provided rental items such that the total value assigned to items provided within a specified period of time is less than the customer's allocation. For example, the value system used may include, without limitation, a point value system, a monetary value system, or a credit value system. The value assigned to each rental item may be based on any criteria, and may be automatically assigned and may automatically vary. Examples of criteria for assigning points to items include, without limitation, current supply and/or demand of the item, expected supply and/or demand for the item, newness of the item in the marketplace, size and/or weight of the item, and the like.

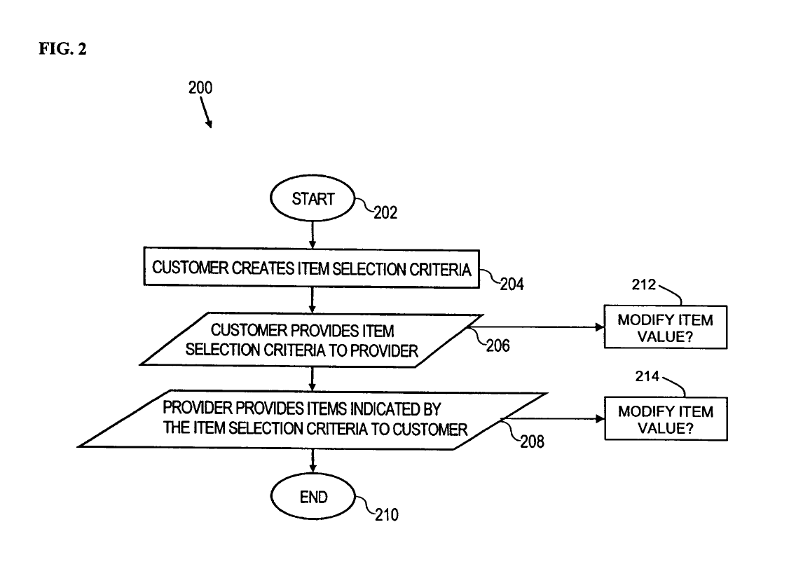

The foregoing methods for renting items to customers will now be described with reference to the flow diagram 200 of FIG. 2. After starting in step 202, in step 204, customer 102 creates item selection criteria. In step 206, customer 102 provides the item selection criteria to provider 104. In step 208, in response to provider 104 receiving the item selection criteria from customer 102, provider 104 provides one or more items indicated by the item selection criteria to customer 102. The process is complete in step 210. In step 212, when customer 102 provides item selection criteria to the provider 104, this indicates an increase in expected demand for the selected items. This increased expected demand for an item may, for example, increase the value, either point value, monetary value, or otherwise specified value, assigned for the given item. In step 214, when provider 104 provides items indicated by the item selection criteria to the customer 102, this reduces the available supply of those rental items while fulfilling expected demand, and thus may also modify the value, either point value, monetary value, or otherwise specified value, assigned for the given item.

2. Item Selection Criteria

The one or more item selection criteria provided by customer 102 to provider 104 indicate the particular items that customer 102 desires to rent from provider 104. Thus, the item selection criteria define a customer-specific order queue that is fulfilled by provider 104. According to one preferred embodiment of the present invention, the item selection criteria specify attributes of items to be provided by provider 104 to customer 102. Item selection criteria may specify any type of item attributes, and the present invention is not limited to particular item attributes. Examples of item attributes include, without limitation, identifier attributes, type attributes, and cost attributes. Item selection criteria may be changed at any time to reflect changes in items that customer 102 desires to rent from provider 104.

3. Item Delivery

According to one preferred embodiment of the present invention, items are delivered by provider 104 to customer 102 over channel 108 based upon item delivery criteria. More specifically, the delivery of items from provider 104 to customer 102 is triggered by item delivery criteria being satisfied. The item delivery criteria may include a wide range of criteria, and the present invention is not limited to any particular item delivery criteria. Examples of item delivery criteria include, without limitation, customer request/notification, customer notification that an item is being returned, customer return of an item, the occurrence of a specified date, the lapse of a specified period of time, or a customer payment.

The item delivery criteria may be specified by customer 102 to provider 104 or negotiated by customer 102 and provider 104 as part of a subscription service. For example, a particular subscription service may include item delivery criteria that assign a value to each rental item, and delivers items to customer 102 from provider 104 monthly up to a specified value. As another example, item delivery criteria may specify that an initial set of items is to be delivered by provider 104 to customer 102 upon initiation of a subscription service and that additional items are to be delivered to customer 102 upon return of items to provider 104.

4. “Simultaneous Value”

According to one preferred embodiment of the present invention, a “SIMULTANEOUS VALUE” method allows up to a specified limit of items to be rented simultaneously to customer 102 by provider 104 based on a limiting criterion by which each rental item is assigned a value, each customer is assigned a specified allocation of value, and the customer may be simultaneously provided rental items such that the total value assigned to items currently provided to customer 102 is less than the customer's allocation. The value assigned to each rental item may be based on any criteria, and may be automatically assigned and may automatically vary. Examples of criteria for assigning values to items include, without limitation, current supply and/or demand for the item, expected supply and/or demand for the item, newness of the item in the marketplace, size and/or weight of the item, and the like. Examples of the value system used include, without limitation, a point value system, a monetary value system, or a credit value system. This method is also independent of the particular item delivery criteria used.

The specified limit may be specific to each customer 102 or may be common to one or more customers. By way of example, if the value system were a points value system, and if the specified allocation of points for customer 102 is 24 points, and if amongst an inventory of rental items, some items were assigned 5 points each, some items were assigned 4 points each, and some items were assigned 3 points each, then customer 102 would be able to simultaneously rent up to four 5-point-items, six 4-point-items, or eight 3-point-items, or other combinations by which the total points assigned to items simultaneously provided is less than or equal to 24 points. If the items currently provided to customer 102 reach the limiting allocation, and the specified item delivery criteria trigger the requested delivery of one or more additional items, then additional items are not delivered until one or more previously provided items are returned by customer 102 to provider 104.

According to another preferred embodiment of the present invention, in situations wherein the items currently provided to customer 102 reach the limiting allocation value and the specified item delivery criteria triggers the requested delivery of one or more additional items, then the one or more additional items are delivered to customer 102 and a surcharge is applied customer 102. The specified allocation of value may then be increased thereafter to reflect the additional items delivered to customer 102. Alternatively, the specified limiting allocation to customer 102 may remain the same and return to the prior level after items are returned to provider 104 by customer 102.

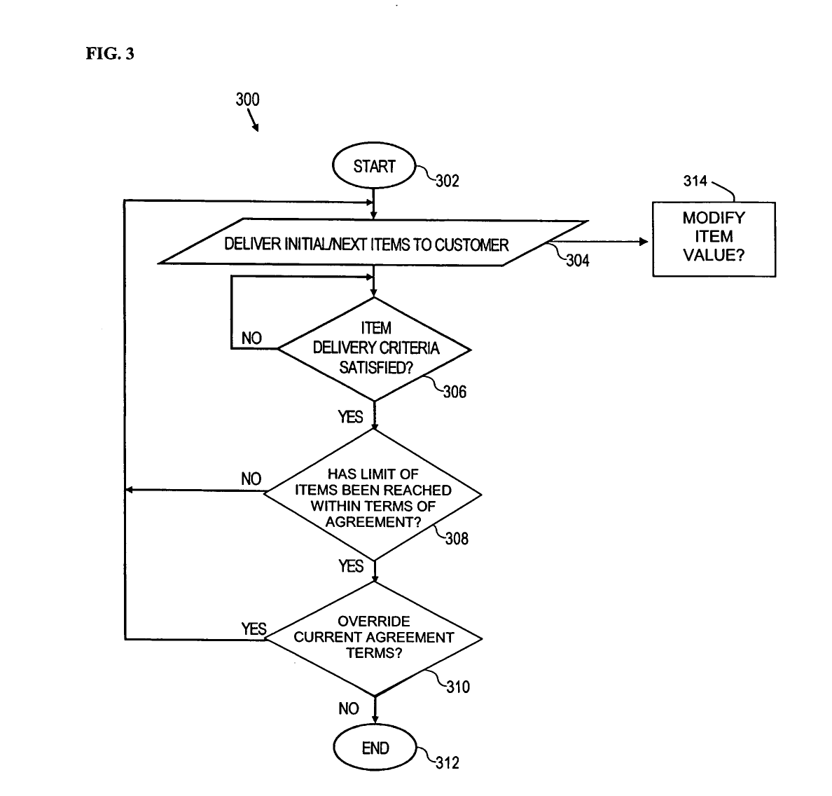

The “SIMULTANEOUS-VALUE” method for managing the number of items that may be simultaneously rented to customers will now be described with reference to the flow diagram 300 of FIG. 3. After starting in step 302, in step 304, one or more initial items are delivered to customer 102 to establish the inventory transferred to customer 102. Note that an initial delivery of items is not required, and according to one preferred embodiment of the present invention, the inventory provided to customer 102 is incrementally established over time.

In step 306, a determination is made whether the item delivery criteria have been satisfied. If not, then the determination continues to be made until the item delivery criteria are satisfied. As described previously herein, the item delivery criteria may include customer notification generally, customer notification that an item is being returned, the actual return of an item, the occurrence of a specific date, or that a specified amount of time has elapsed.

Once the item delivery criteria are satisfied, then in step 308, a determination is made whether the total value assigned to items currently provided to the customer 102 has reached or approached the customer's 102 allocation, such that one or more items in the item selection criteria may not be delivered without exceeding the allocation. If not, then control returns to step 304, and one or more additional items are delivered by provider 104 to customer 102. If, however, in step 308, the further items may not be delivered without exceeding the customer's allocation, then in step 310, a determination is made whether the specified limiting allocation value is to be overridden. As previously described, the limiting allocation value may be overridden to allow additional items to be delivered to customer 102 and charging a fee to customer 102. Alternatively, the specified limiting allocation value is not changed. This process continues for the duration of the subscription and is then complete in step 312.

When provider 104 delivers initial/next items to the customer at step 304, this reduces the available supply of that rental item while fulfilling expected demand, and thus may also result in an automatic modification of the assigned value for a given item 314.

5. “Time Limit-Value”

According to another preferred embodiment of the present invention, a “TIME LIMIT-VALUE” method allows up to a specified limit of items to be rented to customer 102 by provider 104 within a specified period of time, based on a limiting criterion by which each rental item is assigned a value, each customer is assigned a specified allocation of value, and the customer may be provided rental items such that the total value assigned to items provided within the specified period of time is less than the customer's allocation, and/or the number of exchanges does not exceed a limit. The value assigned to each rental item may be based on any criteria, and may be automatically assigned and may automatically vary. Examples of criteria for assigning values to items include, without limitation, current supply and/or demand for the item, expected supply and/or demand for the item, newness of the item in the marketplace, size and/or weight of the item, and the like. Examples of the value system used include, without limitation, a point value system, a monetary value system, or a credit value system. This method is also independent of the particular item delivery criteria used.

The specified limit may be specific to each customer or may be common to one or more customers. In one example, if the value system used were a points value system, and if the specified allocation of points for customer 102 were 24 points every month, and if amongst an inventory of rental items, some items were assigned 5 points each, some items were assigned 4 points each, and some items were assigned 3 points each, then customer 102 would be able to, within the specified time period of one month, rent up to four 5-point items, six 4-point items, or eight 3-point items, or other combinations by which the total points assigned to items provided within one month does not exceed 24 points. If the items currently provided to customer 102 reach the limiting allocation, and the specified item delivery criteria triggers the requested delivery of one or more additional items, then additional items are not delivered until the period of one month has ended. In the present example, if the limit of exchanges were set to four, then customer 102 could, within a one-month period, order a maximum of eight 3-point items, but in no more than four exchanges.

In one situation, customer 102 may not use all of his or her limiting allocation during a specified period. According to one embodiment of the present invention, customers lose unused allocations during a subscription period. For example, if customer 102 has an allocation limit of four item exchanges and 24 points per month, and only makes two item exchanges with a total item value of 12 points in a particular month, then the two unused exchanges and 12 unused points are lost and cannot be used. At the start of the next month, customer 102 would be entitled to four new item exchanges of items with a total value of 24 points.

According to another preferred embodiment of the present invention, customers are allowed to carry over his or her limiting allocation to subsequent subscription periods. For example, if customer 102 has a limit of four item exchanges and 24 points per month and only makes two item exchanges with a total item value of 12 points in a particular month, then the two unused exchanges and 12 unused points are carried over to the subsequent month. At the start of the next month, customer 102 would be entitled to six new item exchanges with a total item value of 36 points, two exchanges and 12 points from the prior month and four exchanges and 24 points for the current month.

According to yet another preferred embodiment of the present invention, in situations where the items provided within one month to customer 102 reach the limiting point allocation and the specified item delivery criteria triggers the requested delivery of one or more additional items, then the one or more additional items are delivered to customer 102 and a surcharge is applied customer 102. The specified allocation of points may then be increased thereafter to reflect the additional items delivered to customer 102. Alternatively, the specified limiting allocation to customer 102 may remain the same and return to the prior level after items are returned to provider 104 by customer 102.

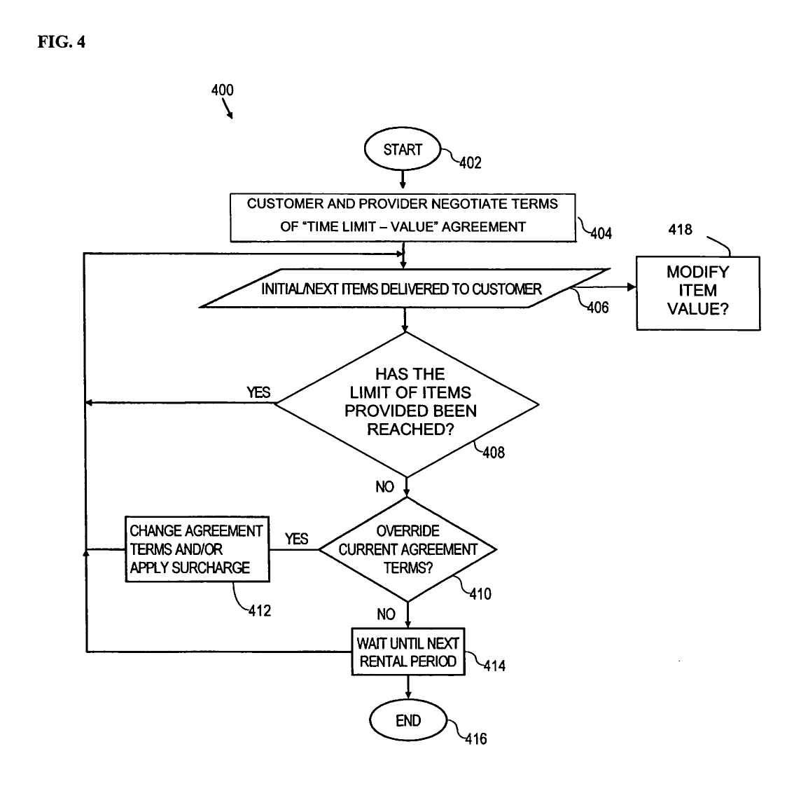

The “TIME LIMIT-VALUE” method for renting items to customers will now be described with reference to the flow diagram 400 of FIG. 4. After starting in step 402, in step 404, customer 102 and provider 104 agree upon the terms of the “TIME LIMIT-VALUE.” Specifically, customer 102 and provider 104 agree at least upon the limiting value allocation for a specified period of time.

In step 406, in response to one or more item delivery criteria being satisfied, provider 104 provides one or more items to customer 102 over delivery channel 108. Any type of item delivery criteria may be used with the “TIME LIMIT-VALUE” method, and the present invention is not limited to any particular item delivery criteria. For example, the initial one or more items may be delivered to customer 102 in response to a subscription payment made by customer 102 to provider 104, the initiation of a specified subscription period, or by request of customer 102 for the initial rental items. The number of initial one or more items must not exceed the terms of the “TIME LIMIT-VALUE” agreement.

In step 408, in response to one or more item delivery criteria being satisfied, a determination is made whether additional items can be provided to customer 102 within the terms of the “TIME LIMIT-VALUE” agreement. For example, if the total value assigned to items provided within the specified period of time is less than the customer's allocation, and/or the number of exchanges does not exceed an agreed-upon limit, then additional items can be rented to customer 102 within the terms of the “TIME LIMIT-VALUE” agreement. In this situation, this determination may be made in response to customer 102 returning one or more items to provider 104, or by customer 102 requesting additional items.

If, in step 408, a determination is made that additional items can be rented to customer 102 within the terms of the “TIME LIMIT-VALUE” agreement, then control returns to step 406 where one or more additional items are rented to customer 102. If, however, in step 408, a determination is made that additional items cannot be rented to customer 102 within the terms of the “TIME LIMIT-VALUE” agreement, then in step 410, a determination is made whether to override the current agreement terms. If so, then in step 412, the agreement terms are changed to allow for further rentals and customer 102 is charged accordingly, or the terms are left unchanged and a surcharge is applied for the further rentals to be delivered. Control then returns to step 406, where one or more additional items are delivered to customer 102.

If in step 410, a determination is made that the current agreement is not to be overridden, then in step 414, no items are delivered to customer 102 until the next subscription period. For example, the request for additional items may be received at the end of a subscription period and instead of renting the additional items immediately, they are instead delivered during the subsequent subscription period. Control then returns to step 406 where one or more additional items are rented to customer 102 or the process is complete in step 416.

Whenever the provider 104 delivers initial/next items to the customer in step 406, this reduces the available supply of that rental item while fulfilling expected demand, and thus may result in an automatic modification of the assigned value for a given item 418.

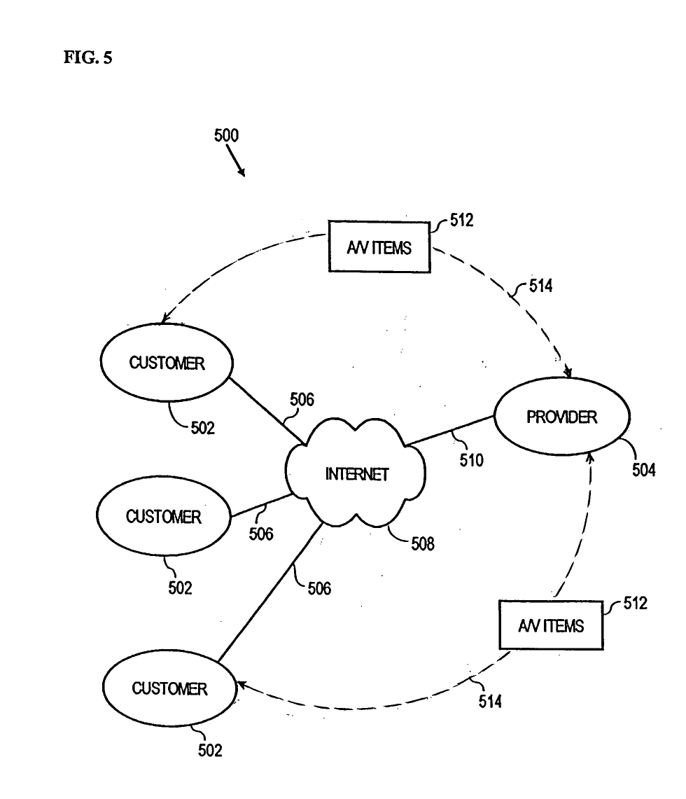

The method for renting items described herein will now be described in the context of renting to customers audio/video (A/V) items, such as movies, games, and music, stored on various media. FIG. 5 is a diagram 500 that depicts a set of customers 502 who desire to rent A/V items from a provider 504. Customers 502 communicate with provider 504 over links 506, the global packet-switched network referred to as the “Internet” 508 and a link 510.

Links 506 and 510 may be any medium for transferring data between customers 502 and the Internet 508 and between the Internet 508 and provider 504, respectively, and the present invention is not limited to any particular medium. In the present example, links 506 and 510 may be connections provided by one or more Internet Service Providers (ISPS) and customers 502 are configured with generic Internet web browsers. Links 506 and 510 may be secure or unsecured depending upon the requirements of a particular application.

In accordance with one preferred embodiment of the present, customers 502 enter into a rental agreement with provider 504 to rent audio/video (A/V) items 512 from provider 504 according to the “TIME LIMIT-VALUE” and/or “SIMULTANEOUS-VALUE” methods described earlier. The present invention is not limited to any particular approach for entering into the rental agreement. For example, customers 502 and provider 504 may enter into a rental agreement by mail, telephone, or over the Internet, by customers 502 logging into a web site associated with provider 504.

Customers 502 create and provide item selection criteria to provider 504 over links 506 and 510 and the Internet 508. The present invention is not limited to any particular approach for specifying and providing item selection criteria to provider 504. For example, according to one preferred embodiment of the present invention, customers 502 provide item selection criteria to provider 504 in one or more data files. According to another preferred embodiment of the present invention, customers 502 log onto a web site of provider 504 and use a graphical user interface (GUI) to specify attributes of the movies and music that customers desire to rent from provider 504.

The item selection attributes may include any attributes that describe, at least in part, movies, games, music, or books that customers 502 desire to rent. For movies, exemplary attributes include, without limitation, title, category, director name, actor name, and year of release. For games, exemplary attributes include, without limitation, title and category. For music, exemplary attributes include, without limitation, title, category, artist/group name, and year of release. For books, exemplary attributes include, without limitation, title, category, author name, and year of publication. Customers 502 may identify specific movies or music by the item selection criteria, or may provide various attributes and allow provider 504 to automatically select particular movies and music that satisfy the attributes specified. For example, customers 502 may specify item selection criteria that include horror movies released in 1999 and let provider 504 automatically select horror movies that were released in 1999. As another example, customers 502 may specify item selection criteria that include adventure movies starring Harrison Ford. Customers 502 may also specify an order or priority for the specified item selection criteria. For example, customers 502 may specify specific movie titles and the order in which they want to receive them. As another example, customers 502 may specify that they want to receive a particular number of movies of different types.

Once customers 502 and provider 504 have entered into a rental agreement and customers 502 have provided item selection criteria to provider 504, then A/V items 512 are rented to customers 502 over delivery channels 514 in accordance with the terms of the rental agreement. Specifically, according to the “SIMULTANEOUS-VALUE” method described herein, an initial set of A/V items 512, such as movies, games, and music, are delivered to customers 502 over delivery channels 514 according to the terms of the rental agreement. Subsequent A/V items 512 are delivered whenever the specified item delivery criteria are satisfied. For example, additional A/V items 512 may be delivered upon the return of one or more A/V items 512 to provider 504, requests from customers 502, the arrival of a particular date, e.g., a specific day of the month, or the expiration of a specified period of time, e.g., fifteen days.

In accordance with the “SIMULTANEOUS-VALUE” method described herein, once the total value assigned to A/V items 512 currently provided to the customer 502 has reached a value by which no more A/V items 512 may be provided under the “SIMULTANEOUS-VALUE” agreement without exceeding the customer's allocation, then no additional A/V items 512 are rented until one or more rented A/V items 512 are returned to provider 504, or unless a surcharge is applied to the particular customer 502. Alternatively, the rental agreement between the particular customer 502 and provider 504 may be modified to increase the maximum allocation value of A/V items 512 that may be rented concurrently to the particular customer 502.

The rental agreements between customers 502 and provider 504 may also specify a maximum number of exchanges in combination with the “SIMULTANEOUS-VALUE” method. In this situation, a maximum number of exchanges restricts how many times a customer 502 may exchange their A/V items 512. In one preferred embodiment of the present invention, an exchange may be defined as occurring when customer 502 returns one item to the provider 504. In another preferred embodiment of the present invention, an exchange may be defined as occurring when customer 502 returns a group of more items to provider 504. In yet another preferred embodiment of the present invention, an exchange may be defined as occurring when provider 504 provides one item to customer 502. In yet another preferred embodiment of the present invention, an exchange may be defined as occurring when provider 504 provides a group of items to customer 502.

For example, suppose that a particular customer 502 agrees with provider 504 to rent movies with an aggregate assigned value of 24 points with a maximum of four exchanges per month, wherein an exchange is defined as occurring whenever customer 502 returns one item or a group of items to provider 504. If the lowest value movie is assigned 3 points, under this agreement, the particular customer 502 may maintain a personal inventory of up to four 3-point movies and may make up to four exchanges per month. If particular customer 502 returned one item in each exchange, then the particular customer would be able replace his entire inventory once during the month. However, if particular customer 502 returned four movies in each exchange, the customer 502 would be able to replace his entire inventory four times per month.

Provider 504 is illustrated as a single entity for purposes of explanation only. Provider 504 may be centralized or distributed depending upon the requirements of a particular application. For example, provider 504 may be a central warehouse from which all A/V items 512 are provided. Alternatively, provider 504 may be implemented by a network of distributed warehouses.

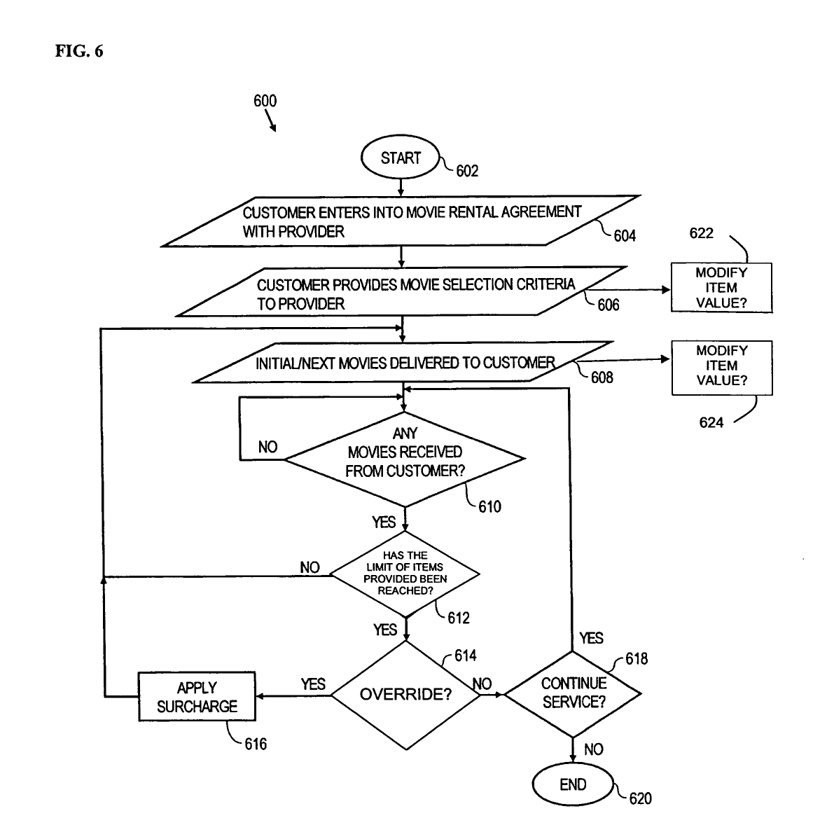

FIG. 6 is a flow diagram that illustrates a method for renting A/V items 512, e.g., movies, to customers 502 over a communications network such as the Internet using both “SIMULTANEOUS-VALUE” and “TIME LIMIT-VALUE” according to one preferred embodiment of the present invention. Referring also to FIG. 5, after starting in step 602, in step 604, customer 502 enters into a rental agreement with provider 504. For example, customer 502 may use a generic web browser to access an Internet web site associated with provider 504 and enter into a rental agreement that specifies that customer 502 may maintain a personal inventory such that the total points assigned to items currently provided is less than 24 points (“SIMULTANEOUS-VALUE” of 24 points) and make up to four exchanges per month worth 48 points per month (“TIME LIMIT-VALUE” of 48 points per month with four exchanges). Furthermore, the rental agreement may specify that a new movie will be delivered upon return of a previously rented movie from customer 502, i.e., the delivery criteria is a return of a movie by the customer.

In step 606, customer 502 creates and provides movie selection criteria to provider 504 that indicates movies that customer 502 desires to rent. For example, the movie selection criteria may specify particular movie titles that customer 502 desires to rent. The movie selection criteria may also specify an order or priority in which customer 502 wishes to rent the movies. Instead of identifying particular movie titles, the movie selection criteria may specify movie preferences for customer 502, e.g., types of movies, directors, actors, or any other movie preferences or attributes. In this situation, provider 504 automatically selects particular titles that satisfy the movie selection criteria. For example, the movie selection criteria may specify a preference for action movies starring a particular actor, with a preference for “new release” movies. Provider 504 attempts to provide movies to customer 502 that best satisfy the preferences indicated by the movie selection criteria.

In step 608, one or more initial movies 512 are delivered to customer 502 over delivery channel 514. The one or more initial movies 512 may be delivered to customer 502 via postal mail, courier, delivery agent, electronically, or any other suitable means negotiated between customer 502 and provider 504, and the present invention is not limited to any particular type of delivery mechanism. In the case of electronic delivery, provider 504 may receive an electronic signal from customer 502 that signifies that the item, such as a movie, which was electronically provided, is no longer active (for example, it has been erased from the customer's system, or the item has been used by the customer and thus is no longer active). Alternatively, the ability of customer 502 to use an electronically delivered item may expire after a period of time, and an additional item(s) may be provided by provider 504 after the passage of time. Accordingly, the criterion which determines whether or not provider 504 delivers an additional item(s) to customer 502 may thus be the use, or further inaccessibility for use, of the item by customer 502 (for example, erasure from the customer's system), and such criterion may be combined with one or more other criteria in accordance with the various embodiment of the present invention. For purposes of explanation only, it is presumed in the present example that movies are mailed between customer 502 and provider 504.

The one or more initial movies 512 establish the current personal movie inventory of customer 502. Customer 502 may choose to receive movies up to the “SIMULTANEOUS-VALUE” limit of defined value such that the total value of points assigned to items concurrently provided does not exceed 24 points.

Once the one or more initial movies 512 have been mailed to customer 502, then in step 610, a determination is made whether any movies 512 have been returned by customer 502 to trigger another movie delivery. In the present example, the delivery of additional movies is triggered by the receipt, e.g., via mail, of one or more movies from customer 502. In the situation wherein customer 502 elects to not receive the maximum limit of movies 512 in the initial delivery, then the delivery of additional movies 512 may also be triggered by a request from customer 502 for additional movies 512. For example, customer 502 may notify provider 504 via telephone, email, or by accessing the web site associated with provider 504.

If, in step 610, a determination is made that one or more movies 512 were received from customer 502, then in step 612, a determination is made whether the maximum number of exchanges or maximum value of points within the month (“TIME LIMIT-VALUE”) has been reached for the current cycle or whether providing the additional movie designated under item selection criteria of customer 502 would make total points assigned to items currently provided greater than the limit (“SIMULTANEOUS-VALUE”). In the present example, a determination is made whether movies with a total value of 48 points have been mailed in the current month, or whether there have already been four exchanges, or whether providing the additional movie designated under item selection criteria of customer 502 would make total points assigned to items currently provided exceed 24 points. If not, then control returns to step 608, where one or more additional movies 512 are mailed to customer 502 via delivery channel 514 up to the “SIMULTANEOUS-VALUE” limit by which total points assigned to items currently provided does not exceed 24 points.

If, in step 612, a determination is made that the “TIME LIMIT-VALUE” limit has been met for the current cycle, i.e., in the present example, four exchanges 512 have occurred with customer 502 in the current month, or movies with a total point value of 48 points have been exchanged, then in step 614 a determination is made whether to override the current “TIME LIMIT-VALUE” limit. If so, then in step 616, a surcharge is applied to customer 502 and control returns to step 608 where the additional movies 512 are mailed to customer 502. If not, then in step 618, a determination is made whether to continue the subscription service. If so, then no additional movies are mailed to customer 502 during the current cycle, e.g., the current month, and control returns to step 610. If, in step 618, a determination is made that service is not to be continued, then the process is complete in step 620.

In some situations, customer 502 may desire to increase or decrease the size of his or her personal movie inventory by changing the current “SIMULTANEOUS-VALUE” limit. According to one preferred embodiment of the present invention, customer 502 notifies provider 504, e.g., by telephone, mail, email, or by accessing the web site associated with provider 504, that customer 502 wishes to change the “SIMULTANEOUS-VALUE” limit. The movie rental agreement between customer 502 and provider 504 is then modified to reflect the change of the “SIMULTANEOUS-VALUE” limit. In the situation wherein the “SIMULTANEOUS-VALUE” limit is increased, then additional movies 512 may be immediately mailed to customer 502.

In some “SIMULTANEOUS-VALUE” or “TIME LIMIT-VALUE” situations, customer 502 may be entitled to delivery of a movie with a lower assigned value according to his or her allocation, but may not be entitled to delivery of a movie with a higher assigned value. For example, customer 502 may have an allocation of 24 points, and may currently be provided movies with a total assigned value of 21 points. In this example, the customer would be entitled to delivery of a movie assigned 3 points, but not to delivery of a movie assigned 4 points. According to one preferred embodiment of the present invention, the provider 504 would deliver the next movie in the queue for customer 602 only if the movie is assigned 3 points or less. However, in accordance with other embodiments and using the current example, provider 504 may deliver the next movie in the queue that is assigned 3 points or less, skipping items in the queue that are assigned more than 3 points. In yet another preferred embodiment of the present invention, the customer 502 may elect between the two alternatives described in the preceding two sentences, and, furthermore, provider 504 may impose a surcharge for either election. These examples describe examples for “SIMULTANEOUS-VALUE” or “TIME LIMIT-VALUE” methods, although it is obvious to one skilled in the art that many approaches may be used.

When customer 502 provides movie selection criteria to provider 504 in step 606, this increases or decreases the expected demand for certain items and may result in an automatic modification in step 622 of the assigned value for a given item. For instance, if customer 502 requested that “Movie A” be delivered in the future, then provider 504 realizes increased expected demand for Movie A and thus may automatically assign a higher point value to Movie A in order to stymie further increased demand so as to assure sufficient supply of Movie A, because the increased demand business criterion is satisfied.

When provider 504 delivers initial/next items to customer 502 in step 608, this reduces the available supply of that rental item while fulfilling expected demand, and thus may also result in an automatic modification in step 624 of the assigned value for a given item. For instance, when customer 502 is mailed “Movie B,” this decreases the provider 604 inventory of Movie B, in the present example, such that there are fewer remaining copies of Movie B to be provided. In order to optimize movie selection for the customers 502 that value Movie B the most, the provider 504 may automatically assign a higher point value to Movie B because the reduced supply business criterion is satisfied.

6. Inventory Management

The method described herein for renting items to customers provides superior inventory management compared to prior approaches. Specifically, the use of item selection criteria provides for efficient inventory management by allowing the provider to moderate demand for the items based on desirability, supply, demand, or any other business criteria by changing the value assigned to items. Furthermore, this method is not limited by the constraints imposed by basing rental agreements on a fixed number of items provided.

Moreover, the greatest number of customers are provided with their most preferred items. For example, customers may specify priorities for the items indicated by the item selection criteria. Thus, if a particular customer's first choice is not available, or already rented, then the item having the next highest priority can be rented to the particular customer. According to one preferred embodiment of the present invention, customers may indicate items that are not yet available for rent. Then, the items are delivered to customers when they become available.

For example, referring again to FIG. 5, suppose that a particular customer 502 desires to rent an as-yet-unreleased movie entitled “ABC.” The particular customer 502 indicates this movie to provider 504 by the item selection criteria. Since the movie ABC is not yet available, it cannot be delivered to the particular customer 502. However, when the movie ABC does become available, it can be shipped immediately to the particular customer 502, as well as other customers 502 who may have also requested the movie. This allows provider 504 to maximize the number of items rented while ensuring that customers 502 are able to rent the highest priority items that they requested.

According to another preferred embodiment of the present invention, as yet unknown items may also be rented by specifying attributes of the unknown items. For example, the particular customer 502 may request to rent the next new movie of a particular director, for which the exact name is unknown to the particular customer. As another example, the particular customer 502 may request to rent the next album of a particular group that is currently in process and does not yet have a title.

7. Implementation Mechanisms

The various embodiments of the method described herein for renting items to customers are applicable to any type of rental application and (without limitation) are particularly well-suited for Internet-based rental applications for renting movies and music to customers. The present invention may be implemented in hardware circuitry, in computer software, or a combination of hardware circuitry and computer software and is not limited to a particular hardware or software implementation.

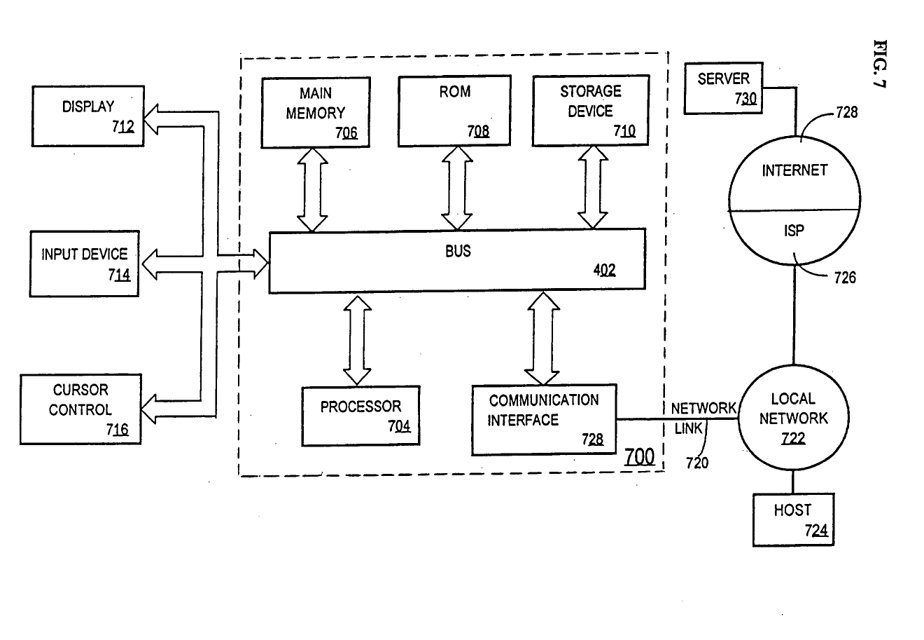

FIG. 7 is a block diagram that illustrates a computer system 700 upon which an embodiment of the present invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Preferably, computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The present invention is related to the use of computer system 700 for renting items to customers. According to one preferred embodiment of the present invention, the renting of items to customers is provided by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement the present invention. Thus, embodiments of the present invention are not limited to any specific combination of hardware circuitry and software.

The term “computer-readable medium” as used herein refers to any medium that participates in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire, and fiber optics, including the wires that comprise bus 702. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read data.

Various forms of computer readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infrared transmitter to convert the data to an infrared signal. An infrared detector coupled to bus 702 can receive the data carried in the infrared signal and place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such an implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722, network link 720, and communication interface 718. In accordance with the present invention, one such downloaded application provides for the renting of items to customers, as described herein.

The received code may be executed by processor 704 as it is received, and/or stored in storage device 710, or other non-volatile storage for later execution. In this manner, computer system 700 may obtain application code in the form of a carrier wave.

The novel method described herein for renting items to customers provides several advantages over prior approaches for renting items to customers. First, the decision of what items to rent may be separated from the decision of when to rent the items. Customers may specify what items to rent using the item selection criteria and receive the items at a future point in time, without having to go to the provider to pick up the items. The selection criteria may be user specific and may indicate a desired fulfillment sequence. Furthermore, customers are not constrained by conventional due dates and instead may establish continuous, serialized rental streams of items. The method also allows more efficient inventory management.

The “SIMULTANEOUS-VALUE” method for inventory management allows customers to maintain their own inventory of items that are periodically replaced by other items according to specified event criteria. The event criteria that trigger sending another item to a customer are very flexible and may be tailored to the requirements of a particular application. For example, as described herein, the event criteria may include a return of any of the items currently in use by the customer or merely customer notification. This is very convenient in the context of movie rentals since the return of a movie to a provider automatically triggers the sending of another movie to the customer. The “TIME LIMIT-VALUE” method for inventory management, when used alone or in combination with “SIMULTANEOUS-VALUE” method, provides even greater flexibility for customers and providers. The maximum number of exchanges can be selected individually for particular customers depending upon their particular needs.

The “SIMULTANEOUS-VALUE” and “TIME LIMIT-VALUE” methods provide great flexibility in establishing subscription models to satisfy the needs of a particular application. Specifically, the size and replacement frequency of customer inventories can be tailored to each customer with individualized subscription plans, while concurrently modifying demand and supply for items based on their value to the customer and value to the provider, respectively.

In the foregoing description, the present invention has been described as applicable to an implementation anticipating Internet based ordering and mail or other long-distance delivery of the rental items, wherein the special advantages of the method are very attractive. However, the same principles of the present invention may be applied in a more conventional video, games, music rental-store setting, where subscription customers may be allowed rentals of a specified number of movies, games, or music selections at any time, and/or in one subscription period, without rental return due dates, in exchange for a periodic rental subscription fee.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

8. Assigning a Value to Each Item

In both “SIMULTANEOUS-VALUE” and “TIME LIMIT-VALUE” methods, an important advantage of the present invention is to automatically or manually assign a value to each item based on any appropriate criteria. The provider may select criteria for assigning value to an item such that the value may change when a customer provides item selection criteria to the provider, when a provider provides items indicated by the item selection criteria to the customer, when an item is returned to the provider, when a certain amount of time has passed since the item has been in the marketplace, or based on any other appropriate criteria.

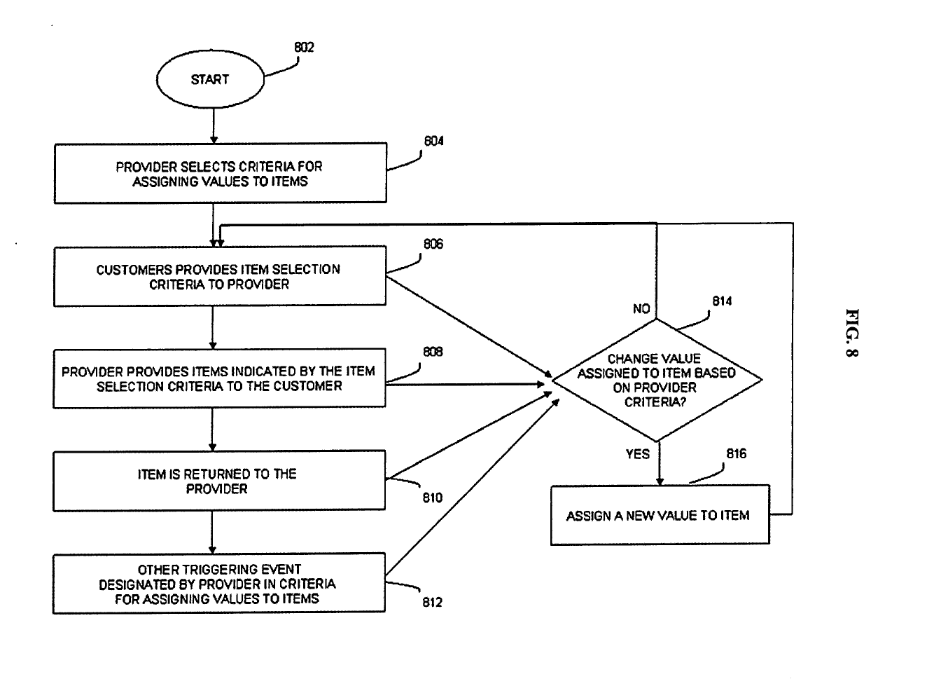

FIG. 8 is a flow diagram that illustrates a method for renting items 512, e.g., movies, to customer 502 over a communications network such as the Internet using both or either “SIMULTANEOUS-VALUE” and “TIME LIMIT-VALUE” according to one preferred embodiment of the present invention. Referring also to FIG. 8, after starting in step 802, in step 804, provider 504 selects criteria for assigning value to items. For example, provider 504 may, for each item, select an inventory level such that when the number of copies currently in inventory of provider 504 reaches the selected level, the value assigned to the item changes. By way of example, provider 504 assigns Movie A a default value of 3 points, provider 504 has a total of 100 copies of Movie A, and provider 504 selects an inventory level of 25 available copies at which the assigned item value changes to 4 points.

In step 808, each time Movie A is provided to a customer 502, it is evaluated in step 814 whether or not the present inventory of Movie A has been reduced to 25 available copies. It follows that if at any time 75 or more copies of Movie A are simultaneously provided to customers, then the number of Movie A copies in inventory has reached the provider's selected inventory level of 25 copies, thus triggering the change in Movie A's value from 3 points to 4 points in step 816 to reflect the decreased supply of Movie A.

In the present example, in step 810, each time Movie A is returned to provider 504, it is evaluated in step 814 whether or not the available supply of Movie A exceeds 25 available copies. It follows that if customers return copies of Movie A to provider 504 such that the provider's current inventory is greater than 25 copies, then the value assigned to Movie A returns to its default assigned value of 3 points.

The value assigned to an item may change between the time that customer 502 provides item selection criteria to provider 504 in step 806, and the time that the item is provided in step 808. Depending on the subscription agreement between customer 502 and provider 504, the value that applies to customer 502 in step 808 when the provider 504 provides items indicated by the item selection criteria may be defined either the value assigned to an item at the time of step 806, when customer 502 provides item selection criteria to provider 504, or the value assigned to an item at the time of step 808, when provider 504 provides the item.

According to one preferred embodiment of the present invention, the value assigned to Movie A applies to customer 502 at the time that customer 502 provides item selection criteria to provider 504. In the present example, customer 502 places Movie A in his queue at a time when Movie A is assigned a value of 3 points, and it follows that the value of 3 points will be assigned to the allocation of customer 502 per his or her subscription agreement in step 808 when the item is provided by the provider. Alternatively, in the present example, if customer 502 had placed Movie A in his queue at a time when Movie A is assigned a value of 4 points, then the value of 4 points would have been assigned to the allocation of customer 502 per his or her subscription agreement in step 808 when the item is provided by the provider. This preferred embodiment of the present invention has the advantage of discouraging customer 502 from including a low-supply or high-demand item in their item selection criteria in step 806, effectively creating price discrimination to match low-supply or high-demand movies with those customers that value them more.

In the present example, customer 502 is in a SIMULTANOUS-VALUE and SIMULTANEOUS-TIME LIMIT agreement with provider 504 such that customer 502 can simultaneously be provided movies with a maximum total value of 12 points, customer 502 may be provided movies within one month with a maximum total value of 36 points, and customer 502 may make up to four exchanges within one month. In the present example, in step 810 of FIG. 8 which corresponds also with step 610 of FIG. 6, customer 502 returns Movie B.

Referring to FIG. 6, in step 612, provider 504 determines whether the limit of items has been reached under the terms of the subscription agreement. In step 612, a determination is made whether the maximum number of exchanges or maximum value of points within the month (“TIME LIMIT-VALUE”) has been reached for the current cycle or whether providing one additional movie designated under the item selection criteria of customer 502 would make total points assigned to items currently provided greater than the limit (“SIMULTANEOUS-VALUE”).

In the present example, a determination is made whether movies with a total value of 36 points have been mailed in the current month, or whether there have already been four exchanges in the current month, or whether providing the additional movie designated under item selection criteria of customer 502 would make total points assigned to items currently provided exceed 12 points. If not, then control returns to step 608, where one or more additional movies 512 are mailed to customer 502 via delivery channel 514 up to the “SIMULTANEOUS-VALUE” limit by which total points assigned to items currently provided does not exceed 12 points. In the present example, in step 612, after it has been determined that Movie B has been returned, if customer 502 has items currently provided with total points assigned as greater than 9 points or if providing an additional movie will cause total value in the current month to exceed 36 points, or if customer 502 has already made four exchanges in the current month, then the process will proceed to step 614 as described previously.

The present example of the preferred embodiment of the present invention illustrates how a system for assigning value to items may be integrated with previously described subscription models. The present example is provided for illustrative purposes only. It may be appreciated by someone skilled in the art that a broad variety of criteria may be used to assign values to items.

According to another preferred embodiment of the present invention, the value assigned to an item may be customer-specific. The criteria for customer-specific value may include any number of appropriate criteria, including but not limited to basing the value, wholly or in part, on the priority a customer places on delivery of the item in the customer's item selection criteria. The advantage may be illustrated by example: if the customer chooses an item for which the provider has low supply, and places the item high in his customer-specific queue requesting a greater priority on delivery, then the value assigned to the item for the customer may increase to reflect dwindling provider inventory of the item, and to create price discrimination by which customers that value the item more than other customers get the item earlier when supply is limited.

In the present example, in step 804, for each item, an inventory level is selected such that a) when the number of copies of Movie A currently in inventory of provider 502 is below 26 copies, and b) when any customer places the item in the first place in his or her queue for delivery immediately subsequent to return of a movie currently provided, then value assigned to Movie A increases from 3 points to 4 points for that customer. In our example, if provider 504 has a total of 100 copies of Movie A, it follows that if at any time 75 or more copies of Movie A are concurrently provided to customers and, if in step 806, customer 502 places Movie A in his or her queue at level one to be the next movie delivered, then in step 814, it is determined that the number of Movie A copies in inventory has reached the selected inventory level of 25 and the customer-specific queue level has been reached, thus triggering the change in Movie A's value from 3 points to 4 points for customer 502 to reflect the decreased supply of Movie A in step 816.

If in step 806 customer 502 moves Movie A to a lower priority in his queue, then in step 814 the value assigned to Movie A returns to its default assigned value of 3 points for customer 502. Under a preferred embodiment of the present invention if in step 810, if customers return copies of Movie A to the provider such that the provider's current inventory is greater than 25, then the value assigned to Movie A returns to its default value of 3 points for future customers that place Movie A in their queue, including for those customers who place Movie A in the top position in their queue.

This example illustrates that one or more triggering events in steps 806, 808, 810, or 812 may be designated by provider 504 in step 804 independently or in conjunction with each other to form criteria used in step 814 to assign a new value to an item in step 816 for all customers or for specific customers. Examples of criteria for assigning value include, without limitation, expected or current demand or supply for each item, expected delivery cost for each item, size of each item, weight of each item, or newness in the marketplace for each item.

According to another preferred embodiment of the present invention, provider 504 compares aggregate demand to aggregate supply in order to assign a value to that item. By way of example, in step 804, provider 504 assigns Movie A a default value of 3 points and selects criteria for assigning values to items such that in step 806, based on the aggregate item selection criteria from the customer base, if the total number of customers who have selected Movie A in their item selection criteria is more than 50% of current supply of Movie A copies as evaluated in step 814, then in step 816 the item is assigned 4 points instead of 3 points to reflect high relative demand of a scarce resource. Once the criteria that the total number of customers who have selected Movie A in their item selection criteria is more than 50% of current supply of Movie A copies as evaluated in step 814 is no longer satisfied, as a result of customers changing their item selection criteria in step 806, or as a result of copies of Movie A completing the rental cycle and being returned in step 810, then the value assigned to the item returns to 3 points in step 816.

According to another preferred embodiment of the present invention, provider 504 may assign values to each item based on their size, weight or shipping cost in step 804. By way of example, provider 504 may assign a value to an item in step 804 such that an item that either a) costs more than $1.00 to deliver to the customer, b) weighs more than 2 ounces, or c) is larger in volume than 10 square inches is automatically assigned a value of 4 points. An item that does not violate any of criteria a), b), or c) is automatically assigned a value of 3 points.

According to another preferred embodiment of the present invention, in step 804, provider 504 may assign values to each item based on time in the marketplace. By way of example, in step 804, a provider may assign a value to each movie such that a movie that has been released to the rental marketplace within one year, designated as a “New Release Movie,” is assigned a value of 4 points. A movie that is released to the rental marketplace after a period of one year is assigned a value of 3 points. As time passes after the release of a movie, in step 812, the passing of time since initial release of a movie is a triggering event that causes step 814. If more than one year has passed since the release of a movie to the rental marketplace in step 814, then the value assigned to the movie changes from 3 points to 4 points in step 816. It may be appreciated by one skilled in the art that any criteria may be used for assigning values to items, and the present examples are shown for illustrative purposes only.

1. A method for renting items to customers, the method comprising the computer-enabled steps of:
receiving one or more item selection criteria that indicates one or more items that a customer desires to rent;
providing to the customer one or more items indicated by the one or more item selection criteria up to a limit indicated by a specified limiting criteria, where the limiting criteria is not defined as the number of items provided;
in response to receiving any of the items provided to the customer, providing to the customer one or more other items indicated by the one or more item selection criteria, up to a limit specified by a limiting criteria where the limiting criteria is not defined as a maximum number of items currently provided, nor is the limiting criteria defined as a maximum number of exchanges within a period of time, nor is the limiting criteria defined as a maximum number of items currently provided in conjunction with a maximum number of exchanges within a period of time.

2. A method as recited in claim 1, further comprising if the customer does not reach the limit defined by limiting criteria, where the limiting criteria is not defined as a maximum number of items currently provided, nor is the limiting criteria defined as a maximum number of exchanges within a period of time, nor is the limiting criteria defined as a maximum number of items currently provided in conjunction with a maximum number of exchanges within a period of time, then increasing the limit specified by the limiting criteria.

3. A method as recited in claim 1, wherein
each customer is allocated a specified number of points, and
where each rentable item is assigned a specified number of points, and
where the limiting criteria are defined such that the total of points assigned to items currently provided to the customer does not exceed the number of points allocated to the customer.

4. A method as recited in claim 3, wherein the specified number of points assigned for each item may vary automatically based on specified business criteria.

5. A method as recited in claim 3, wherein the specified number of points assigned for each item is based, wholly or in part, on a metric of availability for each item.

6. A method as recited in claim 3, wherein the specified number of points assigned for each item is based, wholly or in part, on a metric of expected demand and/or supply for each item.

7. A method as recited in claim 3, wherein the specified number of points assigned for each item is based, wholly or in part, on a metric of current demand and/or supply for each item.

8. A method as recited in claim 3, wherein the specified number of points assigned for each item is based, wholly or in part, on a metric of expected delivery cost for each item.

9. A method as recited in claim 3, wherein the specified number of points assigned for each item is based, wholly or in part, on a metric of newness in the marketplace for each item.

10. A method as recited in claim 4, wherein the specified number of points assigned for each item is, wholly or in part, customer specific.

11. A method as recited in claim 1, wherein
each customer is allocated a specified value, and
where each rentable item is assigned a specified value, and
where the limiting criteria are defined such that the total of value assigned to items currently provided to the customer does not exceed the value allocated to the customer.

12. A method as recited in claim 11, wherein the specified value assigned for each item may vary automatically based on specified business criteria.

13. A method as recited in claim 1, wherein
the one or more item selection criteria indicates a desired order for the one or more items that a customer desires to rent;
the step of providing to the customer one or more items indicated by the one or more item selection criteria up to a limit indicated by a specified limiting criteria, where the limiting criteria is not defined as the number of items provided; includes providing to the customer one or more items up to a limit indicated by a specified limiting criteria, where the limiting criteria is not defined as the number of items provided, in the desired order indicated by the item selection criteria, and
the step of in response to receiving any of the items provided to the customer, providing to the customer one or more other items indicated by the one or more item selection criteria, up to a limit specified by a limiting criteria where the limiting criteria is not defined as a maximum number of items currently provided, nor is the limiting criteria defined as a maximum number of exchanges within a period of time, nor is the limiting criteria defined as a maximum number of items currently provided in conjunction with a maximum number of exchanges within a period of time, includes in response to receiving any of the items provided to the customer, providing to the customer one or more other items indicated by the one or more item selection criteria, up to a limit specified by a limiting criteria where the limiting criteria is not defined as a maximum number of items currently provided, nor is the limiting criteria defined as a maximum number of exchanges within a period of time, nor is the limiting criteria defined as a maximum number of items currently provided in conjunction with a maximum number of exchanges within a period of time, in the desired order indicated by the item selection criteria.

14. A method as recited in claim 13, further comprising if a particular item from the one or more items indicated by the one or more item selection criteria is not available, then providing another item from the one or more items based upon the desired order indicated by the one or more item selection criteria.

15. A method as recited in claim 1, wherein
the one or more item selection criteria specifies one or more preferred item attributes,
the step of providing to the customer one or more items indicated by the one or more item selection criteria up to a limit indicated by a specified limiting criteria, where the limiting criteria is not defined as the number of items provided, includes automatically selecting and providing to the customer up to the limit indicated by a specified limiting criteria one or more items that have one or more item selection criteria, and
the step of in response to receiving any of the items provided to the customer, providing to the customer one or more other items indicated by the one or more item selection criteria, up to a limit specified by a limiting criteria where the limiting criteria is not defined as a maximum number of items currently provided, nor is the limiting criteria defined as a maximum number of exchanges within a period of time, nor is the limiting criteria defined as a maximum number of items currently provided in conjunction with a maximum number of exchanges within a period of time, includes automatically selecting and providing to the customer up to the limit indicated by a specified limiting criteria one or more items that have one or more item selection criteria.

16. A method as recited in claim 1, further comprising:
establishing, based upon the one or more item selection criteria, an item rental queue for the customer, wherein the item rental queue contains one or more entries that specify the one or more items that the customer desires to rent; and
in response to receiving back any of the items provided to the customer, selecting the one or more other items from the item rental queue.

17. A method as recited in claim 1, wherein items are provided to the customer at a retail store.

18. A method as recited in claim 1, wherein items are received at a retail store.

19. A method as recited in claim 1, wherein items are provided to the customer electronically.

20. A method for renting items to customers, the method comprising the computer-enabled steps of:
receiving one or more item selection criteria that indicates one or more items that a customer desires to rent;
assigning a point value to each rentable item;
providing to the customer one or more items indicated by the one or more item selection criteria up to a limit of items such that the total of the points assigned to items currently provided is less than a specified limit;
in response to receiving any of the items provided to the customer, providing to the customer one or more other items indicated by the one or more item selection criteria, up to a limit of items such that the total of the points assigned to items currently provided is less than a specified limit.

21. A method as recited in claim 20, wherein the total points assigned to items provided to the customer within a specified period of time does not exceed a specified limit.

22. A method for renting items to customers, the method comprising the computer-enabled steps of:
receiving one or more item selection criteria that indicates one or more items that a customer desires to rent;
assigning a point value to each rentable item;
providing to the customer one or more items indicated by the one or more item selection criteria up to a limit of items such that the total of the points assigned to items provided is less than a specified limit;
in response to receiving any of the items provided to the customer, providing to the customer one or more other items indicated by the one or more item selection criteria, up to a limit of items such that the total of the points assigned to items provided within a specified period of time is less than a specified limit.

23. A method as recited in claim 22, wherein the total points assigned to items currently provided to the customer does not exceed a specified limit.
